(19) United States
(12) Patent Application Publication
(10) Pub. No.: US 2011/0265123 A1
(43) Pub. Date: Oct. 27, 2011

(54) Method and System for Presenting Customized Content on a Television In Conjunction with Regular Programming

(76) Inventor: Jon Morisey, West Henrietta, NY (US)

(21) Appl. No.: 12/618,966

(22) Filed: Nov. 16, 2009

(51) Int. Cl. H04N 5/445; H04N 5/45; H04N 5/44

(52) U.S. Cl. 725/46; 725/47; 348/734; 348/565; 348/E05.096; 348/E05.112

(57) ABSTRACT

A method and system for presenting content selectable by the viewer on a television screen simultaneously with standard television programming. The system includes a video/audio system such as television, a programming provider such as a television network, a local or remote programming deliverer such as a cable company, a content provider, a local or remote content deliverer, a programming/content integrator that combines the content with the programming for presentation on the television screen, and a viewer settings input. Programming and content can be combined in various ways, including shrinking and/or relocating the programming and using the resulting blank area for content, overlaying content on programming, or presenting content in a inset. Preset viewer setting are stored in an account accessible via the Internet, and may be overridden in real time by a remote control. The remote control is also used to access menus for configuring and/or interacting with the content.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to entertainment and information, more particularly, to systems and methods for receiving information while watching television.

2. Description of the Related Art

A person typically forgets eighty percent of new information within the first twenty-four hours of the first lesson. However, with repetition and review, significant recall can eventually be achieved. Regularly reviewing material improves overall recall of material as time progresses.

Many current training approaches do not recognize the need for refresh reviews. The inventor believes this is a fundamental flaw and reflects the view that passing an exam or test is the main objective of a class. The success of a training course should be judged on the use and retention of the training material after six, twelve, and twenty-four months. The refresh review is a key strategy in helping to achieve long-term retention.

Children receive about six hours of scholastic education per day and watch three to five hours of television per day. Parents want their children to be healthy and successful. Knowledge is now the baseline requirement rather than the exception, but standardized test scores show students losing ground, while time is lacking for every endeavor.

There are a number of systems that permit a subscriber to select programming other than merely choosing a particular channel with standard programming. One example is cable television movies on demand. However, the choices are still limited to those made available by the program deliverer. Another example, Monster on Demand, permits the viewer to search through a jobs data base via the television. However, the viewer is limited to information in the Monster database.

There are other systems where the programming includes other content. Examples include the financial ticker on CNN or the sports ticker on ESPN. However, the ticker content is chosen by the programmer, not the viewer.

There exists a need for a television system whereby a viewer can view two different subjects, the standard programming and viewer-selected content that is independent of the standard programming.

### BRIEF SUMMARY OF THE INVENTION

An object of the present invention is to provide a method and system for a person to learn or remember while watching television.

The present invention is a system and method of presenting customized content (hereinafter, “content”) on a television screen simultaneously with standard television programming (hereinafter, “programming”). The basic system includes a video/audio system such as television, a programming provider, a local or remote programming deliverer, a content provider, a local or remote content deliverer, a programming/content integrator, and a viewer settings input.

The programming provider provides programming for viewing on the television, examples of which include television networks, cable television stations, movie studios, etc.

The programming deliverer delivers programming from the program provider to where it is combined with the content. Local programming deliverers can include, for example, a video disk player, a local computer, a game console, etc. Remote programming deliverers can include, for example, over-the-air signals, cable, satellite, and fiber optic television, and streaming from the Internet.

The content provider provides content to the content deliverer. Content can include any subject matter that the viewer wishes or the content providers can provide. Content can be selected manually in real-time, preselected based on the time of day, or by programming content.

The content deliverer delivers the content to where it is combined with the programming. Local content deliverers can include various media, such as a VCR, a flash drive, and disk storage. Typically, remotely-delivered content will be via the Internet or cellular service.

The programming/content integrator combines the content with the programming for presentation on the television screen, where programming is in a programming view and content is in a content view on the screen. In the shrink view, the programming view is reduced in size and repositioned on the screen. The remaining blank area on the screen is the content view. In the shift view, the programming view is moved to one side of the screen thereby leaving a blank area on the screen for the content view. In the overlay view, the content view is overlaid on the programming view. In the inset view, the content view is an inset within the programming view. The manner of presenting the combined programming/content on the television and the associated options are configured via user profile options.

The programming/content integrator can be local or remote. If local, it can be a separate component or it can be integrated into one of the other components, such as the television. If remote, it can reside with the programming deliverer or the content deliverer or can be independent of the two.

The present invention includes a means for selecting, storing, and retrieving viewer preferences for content delivery. Each household member has an account typically accessible via the Internet. Viewer preferences can be overridden in real time by a remote control device. The remote control can also be used to access menus for configuring the content and/or interacting with the content.

Other objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a basic block diagram of one configuration of the system of the present invention;

FIG. 2 is a diagram of content presentation using a shrink view;

FIG. 3 is a diagram of content presentation using a shift view;

FIG. 4 is a diagram of content presentation using an inset view;

FIG. 5 is a diagram of an example system incorporating the present invention; and

FIG. 6 is a diagram of another example system incorporation the present invention.

### DETAILED DESCRIPTION OF THE INVENTION

The present invention is a system and method of presenting customized content (hereinafter, “content”) on a television screen simultaneously with standard television programming (hereinafter, “programming”) to enable multi-tasking in a modern version of topical “flashcards”.

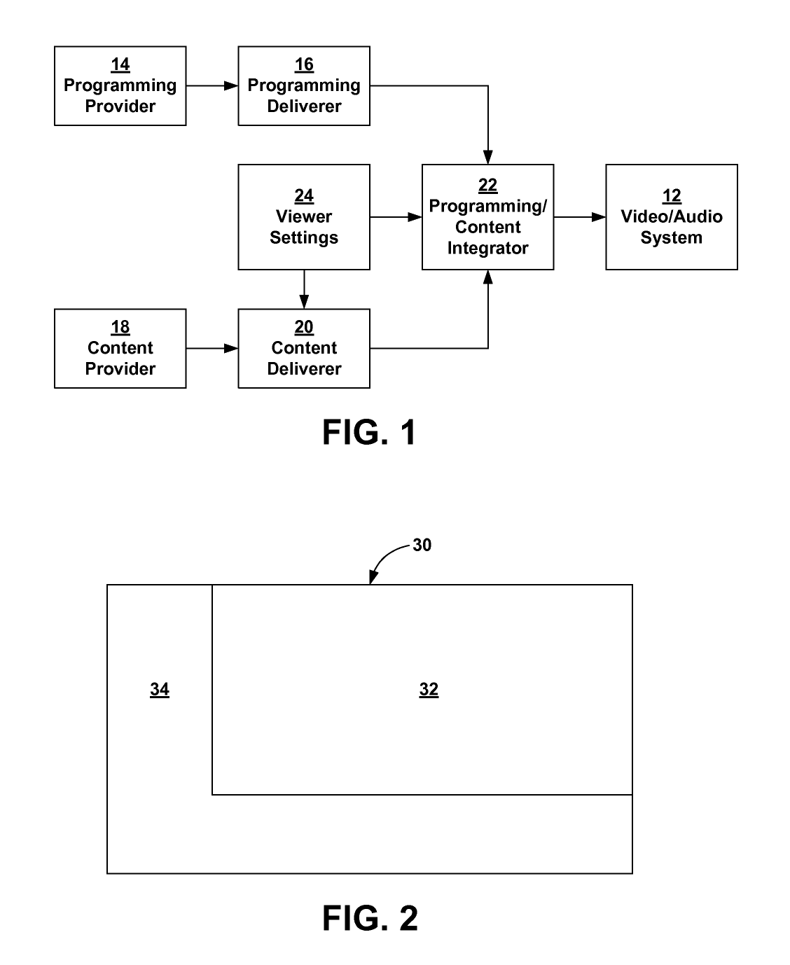

A block diagram of the basic system of the present invention is shown in FIG. 1. The basic components are the video/audio system 12, programming provider 14, programming deliverer 16, content provider 18, content deliverer 20, programming/content integrator 22, and viewer settings input 24.

Typically, the video/audio system 12 is an integrated device, such as a television or computer. Alternatively, the video and audio devices can be separate devices, such as a video monitor and an audio amplifier and speakers as may be found in a home theater system. Some video/audio systems 12 require the use of a decoder or similar device to view cable, satellite, fiber optic, or DSL signals. The present invention contemplates that any form of video/audio system 12 may be used. The present specification and claims uses “television” to refer to the video/audio system 12 and “television screen” to refer to the video display. The television will typically be in a home, but can be anywhere, such as an office, classroom, etc. The term, “home”, is used to refer to the location of the television 12 regardless of where the television 12 may be located.

The programming provider 14 provides programming to the programming deliverer 16 and can be any entity that produces programming that can viewed on the television 12. Examples of programming providers 14 include the television networks, the cable television stations, the movie studios, independent program producers, video game programmers, etc.

The programming deliverer 16 is the source of the programming delivered to where the content is combined with the programming. The programming deliverer 16 can be local or remote. Local programming deliverers are those that do not require a connection outside the home and can include, for example, a VCR/VCP, a DVD/Blu-Ray player, a DVR, a local computer, a game console, disk storage, a still camera, and a video camera. The media may be rented or purchased. Remote programming deliverers are those where the programming is received from outside the home and can include, for example, over-the-air signals via an antenna, cable television, DSL over telephone lines, fiber optic television, satellite television, and streaming from the Internet. Any of these programming delivery sources can be adapted to use the system and method of the present invention.

Programming is received from the programming deliverer 16 in a particular format for viewing on the television 12. In a typical environment, the television 12 receives the programming signal and, if necessary, reformats it for the television screen 30. For example, if the screen 30 has a 16:9 aspect ratio, a 16:9 aspect ratio program fills the screen. On the other hand, a 3:2 aspect ratio program is centered horizontally on the 16:9-aspect-ratio screen 30 and bars fill the remainder of the screen on either side of the program. Conversely, if the screen 30 has a 3:2 aspect ratio, a 16:9 aspect ratio program is centered vertically on the screen 30 and bars fill the remainder of the screen above and below the program.

The content provider 18 provides content to the content deliverer 20. Various types of content are described below.

The content deliverer 20 is the source of the content delivered to where the content is combined with the programming. The content deliverer 20 can be local or remote. Local content deliverers are those that do not require a connection outside the home and can include various media, for example, a VCR/VCP, a DVD/Blu-Ray player, a DVR, a flash drive, a CD-ROM drive, disk storage, and a computer. The media may be rented or purchased.

Remote content deliverers are those where the content is received from outside the home. Typically, remotely-delivered content will be via a global computer network, such as the Internet, or via a wide-area wireless data network, such as a 3G mobile telephone network.

The programming/content integrator 22 combines the content with the programming for presentation on the television screen 30. The present invention contemplates several different scenarios for presenting combined programming/content on the screen 30. In the shrink view, an example of which is shown in FIG. 2, the programming view 32 is reduced in size and repositioned on the screen 30 while maintaining its aspect ratio. The remaining blank area on the screen 30 is the content view 34. The shrink view works well for systems where the programming aspect ratio is the same as the television aspect ratio, for example, a programming aspect ratio of 4:3 on a television with an aspect ratio of 4:3 or a programming aspect ratio of 16:9 on a television with an aspect ratio of 16:9. The content is presented in the content view 34. The position of the programming view 32 on the screen 30 determines the location of the content view 34. For example, if the programming view 32 is positioned in an upper corner of the screen 30, the content view 34 will be on one side and below the programming view 32. If the programming view 32 is positioned in the center of the screen 30, the content view 34 will surround the programming view 32. Optionally, the aspect ratio is not maintained and the programming view 32 is stretched or compressed as needed to provide the content view 34.

The amount by which the programming view 32 is reduced in size can be determined in several ways: (1) by the area necessary to present the content, that is, by the content deliverer 20; (2) by the viewer through the viewer settings 24; and/or (3) by the programming deliverer 16. If more than one source can determine the programming view reduction, a preference hierarchy can be established. If the content view 34 remaining after programming view reduction is not sufficient to display all of the content, the content may be scrolled within the content view 34 at a rate determined by the content deliverer 20 and/or the viewer.

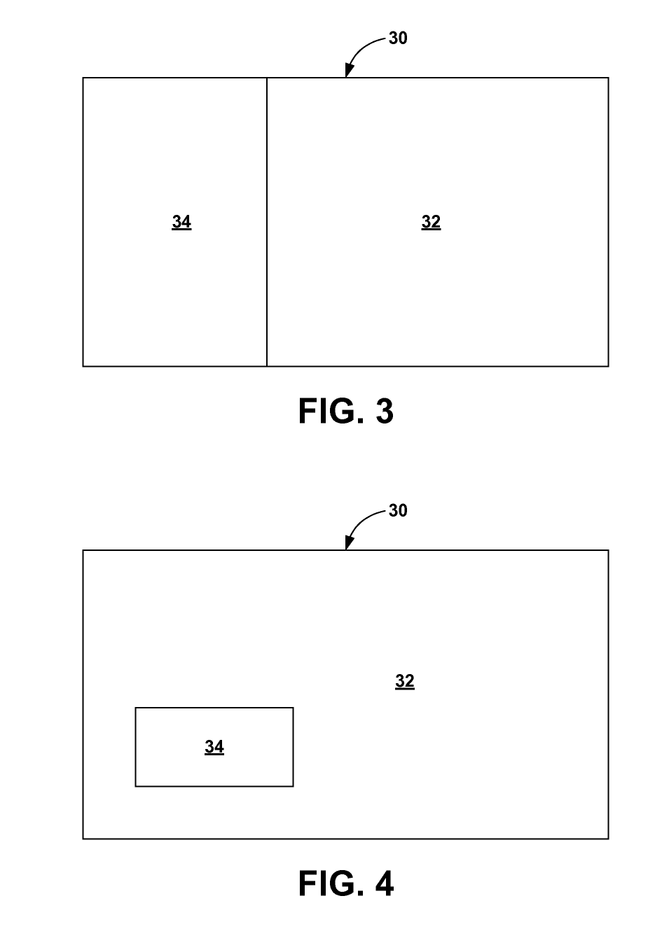

In the shift view, an example of which is shown in FIG. 3, the programming view 32 is moved to one side of the screen 30 while maintaining the aspect ratio, thereby leaving a blank area on the screen 30 for the content view 34. The shift view works well for systems where the programming aspect ratio is not the same as the television aspect ratio, for example, a programming aspect ratio of 4:3 on a television with an aspect ratio of 16:9. The position of the programming view 32 on the screen 30 determines the location of the content view 34. For example, if the programming view 32 is positioned on the right side of the screen 30, the content view 34 will be to the left of the programming view 32. If the programming view 32 is positioned in the center of the screen 30, the content view 34 will be on both sides of the programming view 32.

In the overlay view, not shown, the content view is overlaid on the programming view. The overlay can cover the entire programming view or only a portion, as selected by the viewer. The transparency or opacity of the content overlay can be adjusted so that more or less of the programming view can be seen through the overlay.

In the inset view, shown in FIG. 4, the content view 34 is an inset within the programming view 32, as in a picture-in-picture format. The location of the content view 34 can be selected by the viewer.

The size of the content view 34 can be determined in several ways: (1) by the area necessary to present the content, that is, by the content deliverer 20; (2) by the viewer through the viewer settings 24; and/or (3) by the programming deliverer 16. If more than one source can determine the size of the content view 34, a preference hierarchy can be established. If the size of the content view 34 is not sufficient to display all of the content, the content may be scrolled within the content view 34 at a rate determined by the content deliverer 20 and/or the viewer.

The manner of presenting the combined programming/content on the television and the associated options are configured via user profile options as described below. The present invention also contemplates that the user can override any of the options in real time and further command that the content view 34 take over the entire screen 30.

As contemplated by the present invention, the programming/content integrator 22 can reside in several different locations. Where the programming deliverer 16 is local, as described above, the integrator 22 is local. In one example, the integrator 22 is a set-top box with inputs for programming and content and an output to the television. Programming is received from the programming deliver and content is received from a local or remote source, as described below. In another example, the integrator 22 is incorporated into the television so that the programming and content are inputted directly to the television 12. In another example, the integrator 22 is a personal computer so that the programming input and the television output are on a personal computer and the content input is via its Internet connection.

The programming input on the integrator 22 is the same as would be found on a television 12. Over the years, many different video/audio signal transmission standards have been developed including, for example, composite video, component video, S-video, HDMI, etc., each with its own connector type. The integrator 22 may accept any one or more video signals for the programming input.

The present invention contemplates that the content input will be fed by a global computer network, such as the Internet, or a wide-area wireless data network, such as a 3G mobile telephone network. The Internet is typically wired into the home via a telephone line, coaxial cable, optical fiber, or satellite antenna. Within the home, the Internet may be distributed via a wired local area network (LAN), such as an Ethernet, or a wireless LAN.

A mobile telephone network is delivered wirelessly via a mobile device or cellular modem. If a mobile device, such as a mobile phone or PDS, is used, it needs to connect to the integrator 22, which can be done in any number of different ways including a USB cable, Bluetooth, and infrared. A cellular modem is typically designed into the integrator 22. Alternatively, it can be connected to the Integrator 22 via an internal PC-style card slot.

Where the programming deliverer 16 is remote, as described above, the integrator 22 is either local, as described above, or remote. In one example, combining is done directly by the programming deliverer 16 at the remote location of the programming deliverer 16. The content deliverer 20 delivers content to the programming deliverer 16 for combining with the programming. The combined content/programming is then delivered from the remote location of the programming deliverer 16 to the television 12 via the programming deliverer's normal mode of programming delivery, as described above.

In another example, combining is done directly by the content deliverer 20 at the remote location of the content deliverer 20. The programming deliverer 16 delivers programming to the content deliverer 20 for combining with the content. The combined content/programming is then delivered from the remote location of the content deliverer 20 to the television 12 via the content deliverer's normal mode of content delivery. The present invention contemplates any method of delivery available to the programming deliverer 16.

In another example, combining is done at a remote location by an integrator 22 separate from the programming deliverer 16 or content deliverer 20. The programming deliverer 16 delivers programming and the content deliverer 20 delivers content to the integrator 22 for combining. The combined content/programming is then delivered from the remote location of the integrator 22 to the television 12. The present invention contemplates any method of delivery available to the programming deliverer 16 or the content deliverer 20.

The present invention prefers, but does not require, a local integrator 22. By decoupling the programming and content data streams, less bandwidth is required than by delivering combined programming and content. This is because the special stream that originates the combined programming/content to be delivered to a particular viewer at a given time will not need to be created for each user.

Content can include any subject matter that the viewer wishes or the content providers can provide. Examples include scholastic education, exercise, entertainment, “how to” instruction, news, sales, and advertising. The actual appearance of the content in the content view 34 will be determined by the subject matter. For example, if the content is in the form of flash cards, the content view could alternate between a word or phrase to be learned and its meaning. The word or phrase will change periodically. If the content is news, or other information, it could be presented as a “ticker” in the content view. If the content is instructional, exercise, sales, or advertising, it could be presented as a video in the content view. The previous examples are mere illustrative and are not intended to describe the only way that the particular content can be presented.

Content selection has two basic parameters: what is presented and when it is presented. The present invention contemplates a number of ways to determine what and when content is presented. One way is that the content is selected manually, that is, if the viewer wishes to view content with the programming, the viewer, using viewer settings 24, selects the content to be presented. Another way is by the viewer inputting his/her identity via a code or other means to view predetermined content. Another way is by time of day, that is, preselected content is presented at a particular time of day. Yet another way is by programming content. For example, information included with a program includes program identification, such as the program title. The title can be used to select predetermined content for presentation. In another example, program directories found on cable, satellite, and DSL systems identify the general subject matter of the programming, such as sports, news, children, movies, etc. This subject matter identification can be used to select predetermined content for presentation.

The present invention includes a means for selecting, storing, and retrieving viewer preferences for content delivery. Each member of a household has an account in which these preferences are set up. The physical location of the account is not important, but should be where the content provider 18, content deliverer 20, and/or programming deliverer 16 either has access or can receive information in response to a request. Access to and/or requests for information from the account can be via a site on the Internet or other means. For example, an interactive cable television interface can be used if the programming deliverer 16 is capable of passing the necessary information on to whomever needs it.

Viewer preferences can include, but are not limited to, presentation parameters, content subject, content delivery time. Presentation parameters include the content view type (programming view reduction, shift, overlay, and inset), the content view size and location, and the level of transparency for the overlay. The present invention contemplates that viewer preferences can be overridden in real time by the remote control device.

Content can be customized for particular viewers. For example, flashcard content can be synched to educational institution's curriculum so that it can be tailored to match an educational curriculum as appropriate for each viewer in order to reinforce educational concepts, standardized across states, and matched to approved course content. Before and after quizzes on the content can be delivered to chart student progress.

Programming has traditionally been controlled on the television 12 itself or by remote control device. More recently, programming and secondary devices (TiVo, DVR) can be controlled via a Web site or a mobile phone. These methods will also be available to users of the present invention. In the same manner, content can be controlled and configured via a choice of the remote control, Web site, or mobile devices such as cell phones, PDA, or other such devices that allow the user to enter data via a network-connected system.

A remote control device suitable for the present invention is able to issue infrared and/or radio commands to the appropriate system components that control both programming and content. The remote optionally includes gaming controls, WII-like motion sensors, and/or a keyboard similar to those found in small cellular devices.

Menus for configuring the content and/or interacting with the content are invoked via the remote as well. The menus are retrieved from the content provider 18 on demand. The retrieval of such information includes not only the content, but also parameters configured by the user that control the appearance on the television screen 30. These parameters allow the content and programming to be combined on screen for the user to create the proper programming and content views.

The menus can interact and control devices that are directly attached to the television 12 or are accessible via a wired or wireless network. This interaction could also access presentations containing content stored on Web pages in standardized formats.

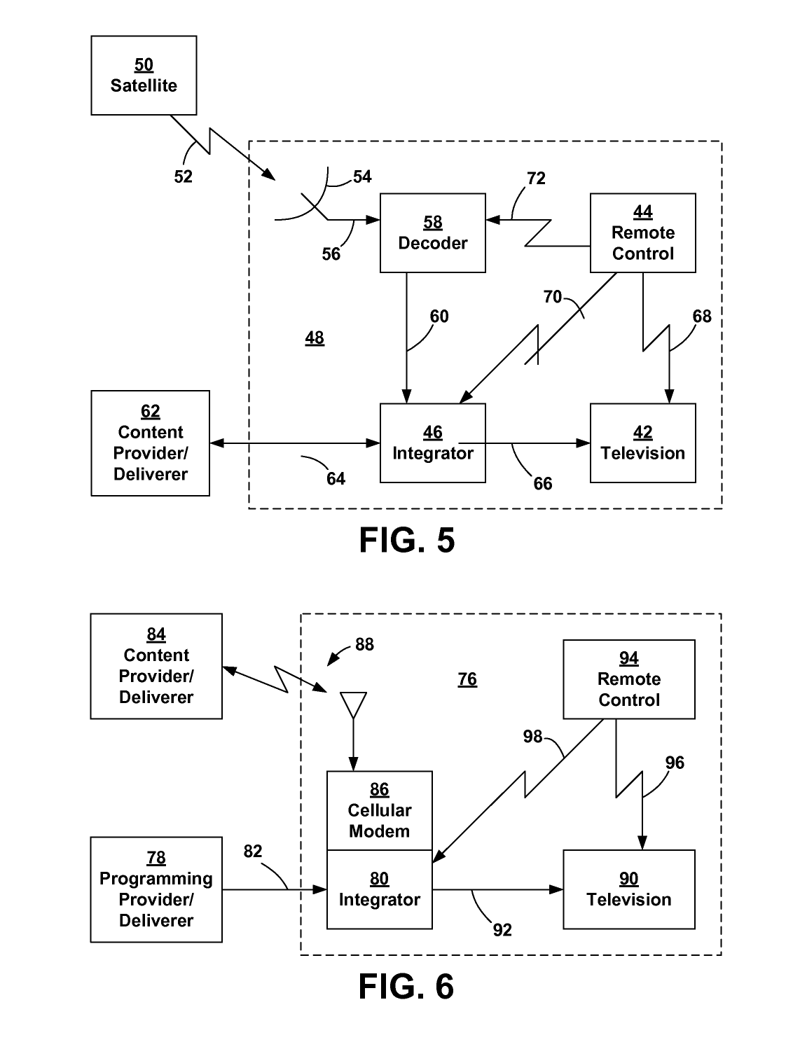

One example system incorporating the present invention is shown in FIG. 5. The programming is delivered from a satellite 50. The satellite signal 52 is received by an antenna 54 at the home 48 and sent, via a coaxial cable 56, to a decoder 58. The decoder 58 may also incorporate a digital video recorder (DVR). The output of the decoder 58 is connected to the programming deliverer input of the programming/content integrator 46, as at 60.

The content provider/deliverer 62 is a computer that is connected to the content input of the integrator 46 via the Internet, as at 64. The output of the integrator 46 is connected to the input of the television, as at 66.

A wireless remote control 44 is used to send instructions to the television 42, integrator 46, and decoder 58, as at 68, 70, and 72, respectively. Instructions specific to the television 42, such as volume, are ignored by the decoder 58 and integrator 46. Instructions specific to the decoder 58, such as channel number, are ignored by the television 42 and integrator 46. Instructions specific to the content provider 62 and/or integrator 46, such as content view or content subject, are ignored by the television 42 and decoder 58. If the integrator 46 receives instructions directed to the content provider 62, the instructions are forwarded to the content provider 62 via the Internet 64.

Another example system incorporating the present invention is shown in FIG. 6. The programming is delivered from a coaxial cable 78 directly to the programming deliverer input of the programming/content integrator 80, as at 82, in the home 76. The content provider/deliverer 84 is a computer that is connected to the mobile phone network of the user. A cellular modem 86 is designed into the integrator 80 and receives content via the user's mobile phone network, as at 88. The output of the integrator 80 is connected to the input of the television 90, as at 92.

A wireless remote control 94 is used to send instructions to the television 90 and integrator 80, as at 96 and 98, respectively. Instructions specific to the television 90, such as volume, are ignored by the integrator 80. Instructions specific to the content provider 84 and/or integrator 80, such as content view or content subject, are ignored by the television 90. If the integrator 80 receives instructions directed to the content provider 84, the instructions are forwarded to the content provider 84 via the cellular modem 86 and the users mobile phone network, as at 88.

Thus it has been shown and described a method and system for presenting customized content on a television in conjunction with regular programming which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

What is claimed is:

1. A system for presenting to a viewer customized content from a content provider on a television in conjunction with regular programming from a programming provider, said system comprising:
(a) a television having a screen;
(b) an integrator that receives said programming and receives said content, combines said programming and said content, and outputs said combined programming/content to said television screen, said integrator combining said programming and content such that said programming is in a programming view on said screen and said content is in a content view on said screen; and
(c) a means for enabling said viewer to select said content;
(d) a means for retrievably storing viewer preferences related to said content.

2. The system of claim 1 wherein said content is received from a global computer network.

3. The system of claim 1 wherein said content is received from a mobile telephone network.

4. The system of claim 1 further comprising a remote control for sending instructions to said content provider.

5. The system of claim 1 wherein said integrator combines said programming and content such that said programming is reduced in size and the remaining portion of said screen is said content view.

6. The system of claim 5 wherein the amount that said programming view is reduced is adjustable.

7. The system of claim 1 wherein said integrator combines said programming and content such that said programming view is repositioned on said screen and the remaining portion of said screen is said content view.

8. The system of claim 1 wherein said integrator combines said programming and content such that said content view is an inset within said programming view.

9. The system of claim 8 wherein the size and position of said inset on said screen is adjustable.

10. The system of claim 1 wherein said integrator combines said programming and content such that said content view overlays at least a portion of said programming view.

11. The system of claim 10 wherein the opacity of said content view is adjustable.

12. The system of claim 1 wherein said integrator and said television are at the same location.

13. A method for presenting to a viewer customized content from a content provider on a television in conjunction with regular programming from a programming provider, said method comprising:
(a) permitting said viewer to select said content;
(b) receiving said regular programming;
(c) receiving said content;
(d) combining said programming and said content such that said programming in is a programming view and said content is in a content view; and
(e) presenting said combined programming and content to said viewer.

14. The method of claim 13 wherein said content is received via a global computer network.

15. The method of claim 12 wherein said content is received via a mobile telephone network.

16. The method of claim 13 further comprising providing access to a database for retrievably storing viewer preferences related to said content, said content being customized based on said viewer preferences.

17. The method of claim 13 wherein said viewer is permitted to select said content with a remote control.

18. The method of claim 13 wherein combining said programming and content includes reducing the size of said programming and employing the remaining portion of said screen as said content view.

19. The method of claim 18 wherein the amount that said programming is reduced adjustable.

20. The method of claim 13 wherein combining said programming and content includes repositioning said programming on said screen and employing the remaining portion of said screen as said content view.

21. The method of claim 13 wherein combining said programming and content includes presenting said content view as an inset within said programming view.

22. The method of claim 21 wherein the size and position of said inset on said screen is adjustable.

23. The method of claim 13 wherein combining said programming and content includes overlaying said content view over at least a portion of said programming view.

24. The method of claim 23 wherein the opacity of said content view is adjustable.
